(19) United States
(12) Patent Application Publication
(10) Pub. No.: US 2010/0002793 A1
(43) Pub. Date: Jan. 7, 2010

(54) METHOD AND APPARATUS FOR CODING RELATING TO A FORWARD LOOP

(75) Inventors: Peter R. Dent, Irthingborough (GB); Eric Biscondi, Opio (FR); David Hoyle, Austin, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/496,538

(22) Filed: Jul. 1, 2009

Related U.S. Application Data
(60) Provisional application No. 61/077,749, filed on Jul. 2, 2008.

(51) Int. Cl. H04L 5/12

(52) U.S. Cl. 375/265

(57) ABSTRACT

A high data width accelerator, comprising computer instructions for calculating at least a portion of a trace-back during a trellis computation, wherein the calculation allows faster trace-back

### CROSS-REFERENCE TO RELATED APPLICATIONS

This application claims benefit of U.S. provisional patent application Ser. No. 61/077,749, filed Jul. 02, 2008, which is herein incorporated by reference.

### BACKGROUND OF THE INVENTION

1. Field of the Invention

Embodiments of the present invention generally relate to a method and apparatus for calculating at least a portion of a trace-back during a trellis computation.

2. Description of the Related Art

The trellis diagram of FIG. 1 helps explain the Viterbi algorithm. FIG. 1 shows the trellis diagram with a rate ½ K=3 convolutional encoder, for a 15-bit message. The four possible states of the encoder are depicted as four rows of horizontal dots. There is one column of four dots for the initial state of the encoder and one for each time instant during the message. For a 15-bit message with two encoder memory flushing bits, there are 17 time instants in addition to t=0, which represents the initial condition of the encoder. The solid lines connecting dots in the diagram represent state transitions when the input bit is a one. The dotted lines represent state transitions when the input bit is a zero. Notice the correspondence between the arrows in the trellis diagram and the state transition table. Also, since the initial condition of the encoder is State 002, and the two memory flushing bits are zeroes, the arrows start out at State 002 and end up at the same state.

FIG. 2 shows the states of the trellis that are reached during the encoding of our example 15-bit message. The encoder input bits and output symbols are shown at the bottom of the diagram. Notice the correspondence between the encoder output symbols and the output table.

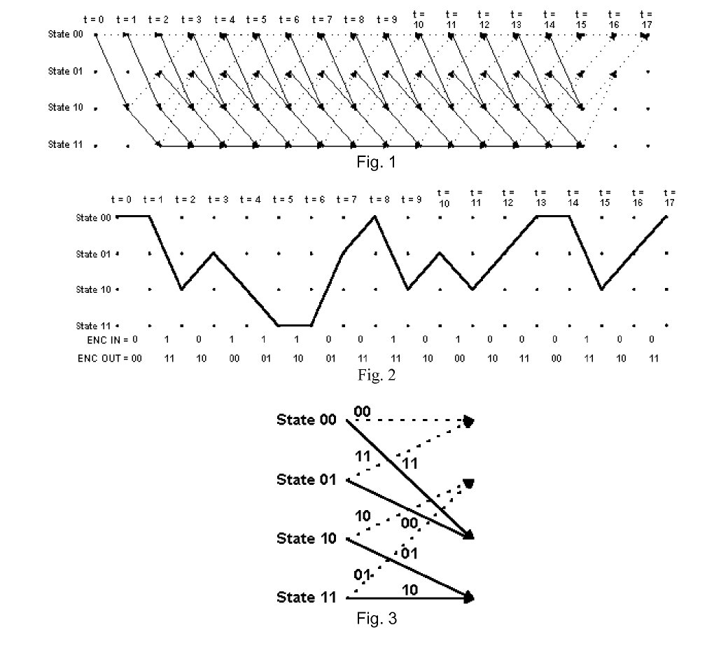

FIG. 3 depicts the expanded version of the transition between one time instant to the next. The two-bit numbers labeling the lines are the corresponding convolutional encoder channel symbol outputs; whereas, the dotted lines represent cases where the encoder input is a zero. The solid lines represent cases where the encoder input is a one.

### SUMMARY OF THE INVENTION

Embodiments of the present invention relate to a high data width accelerator, comprising computer instructions for calculating at least a portion of a trace-back during a trellis computation, wherein the calculation allows faster trace-back.

### BACKGROUND OF THE INVENTION

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1. depicts an embodiment of is a trellis diagram;

FIG. 2 depicts an embodiment of states of the trellis;

FIG. 3 depicts an embodiment of an expanded version of transition between one time instant to another;

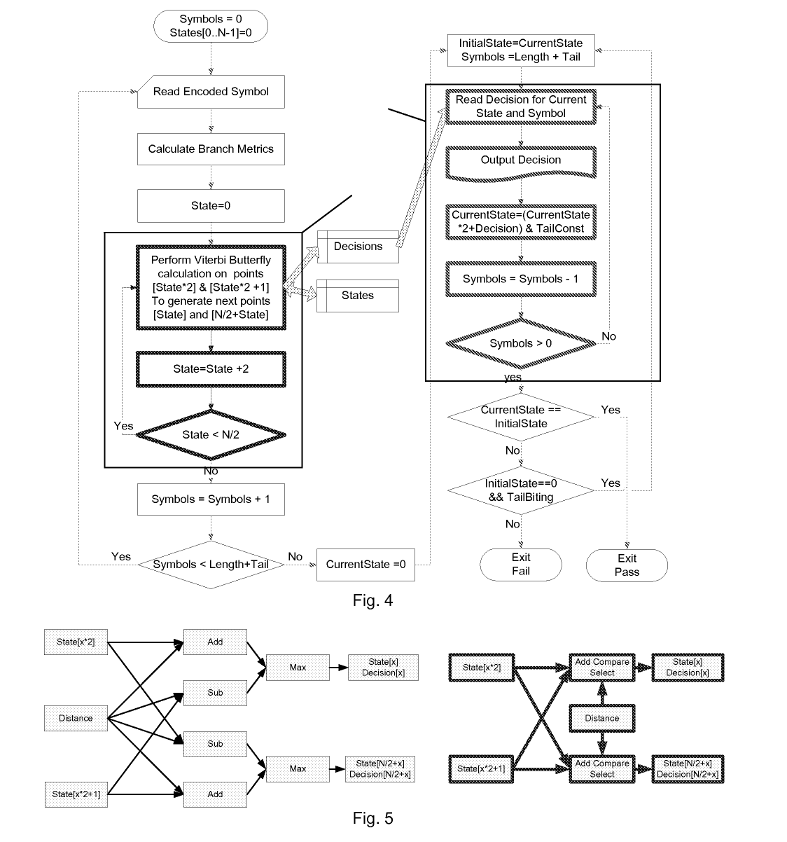

FIG. 4 depicts an embodiment of a flow diagram for a method of decoding;

FIG. 5. depicts an embodiment of flow diagram for a method for reversing the addition and subtraction;

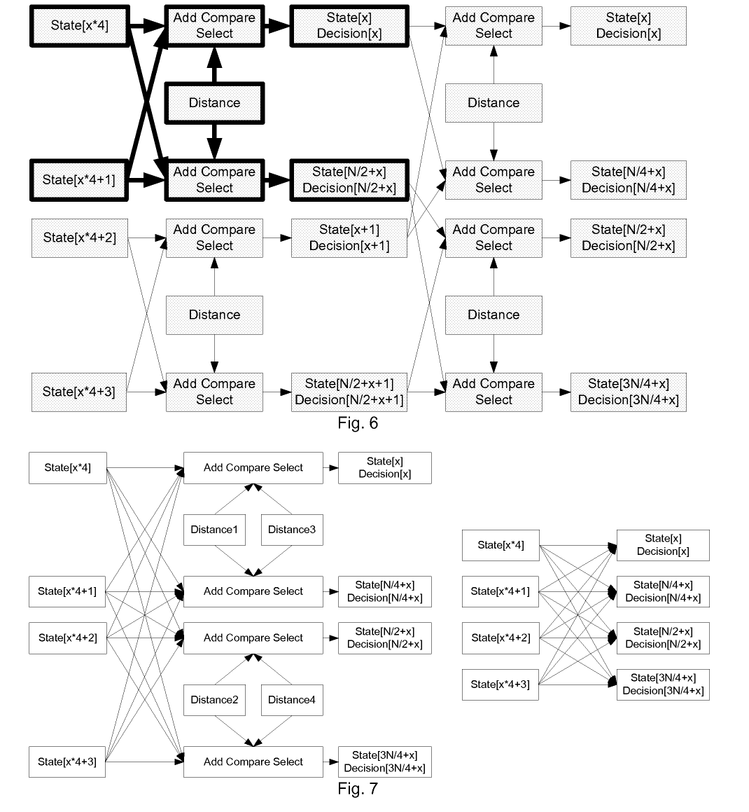

FIG. 6 depicts an embodiment of a flow diagram for a method for performing parallelism;

FIG. 7 is a depiction of an embodiment used for a trellis stage;

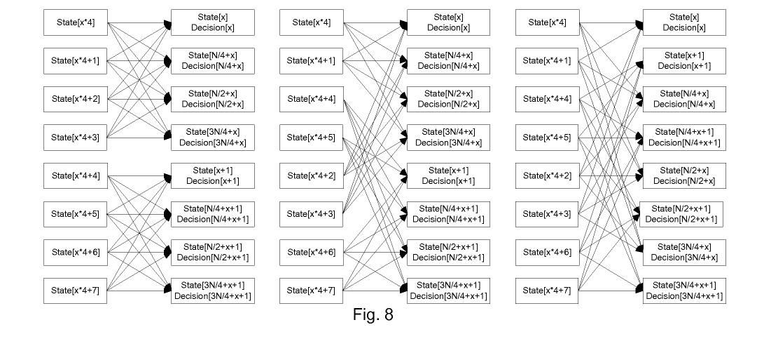

FIG. 8 depicts an embodiment of three (3) orders for ordering states in the two radix-4 stage solution;

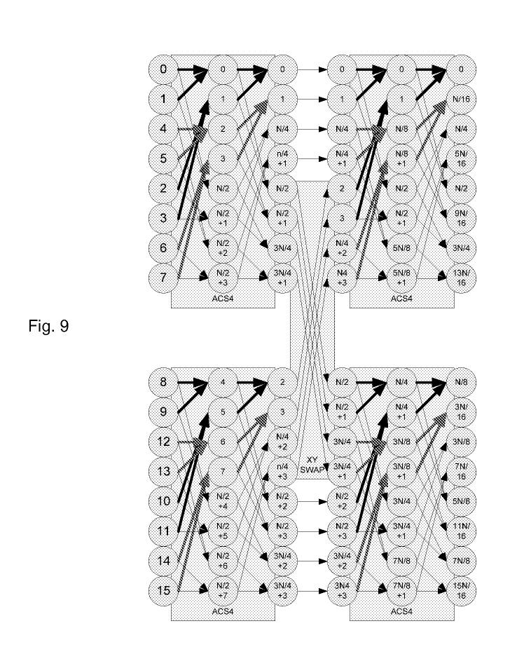

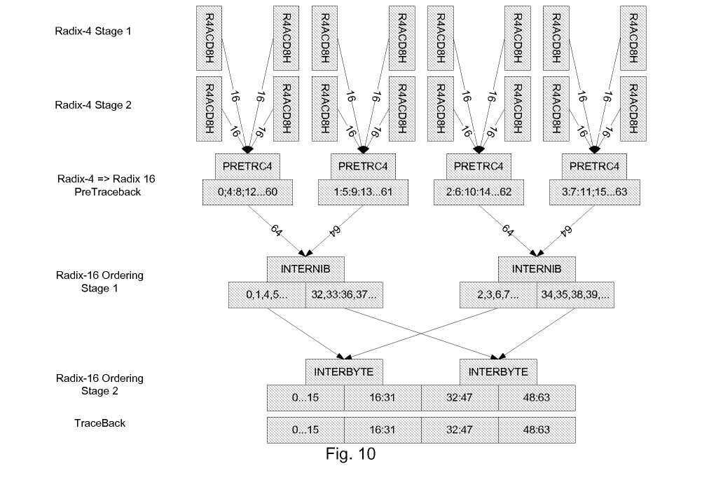

FIG. 9 depicts an embodiment of an implementation of four (4) inner loops and two (2) outer loops of the first stage; and

FIG. 10 depicts an embodiment of converting from four (4) sets of eight 2-bit stages to one (1) set of 16 4-bit stages.

### DETAILED DESCRIPTION

The decoding algorithm consists of a series of 2 loops the first of which may contain an inner loop. The second loop maybe a single loop which may be repeated a second time in some versions of the algorithm. The generic flow chart is shown in FIG. 4. (=, ==, &, && have their ANSI-C definitions).

However the core of the algorithm consists of the two loops. Loop 1 is commonly called the “forward” loop and loop 2 the “trace-back” loop.

It should be noted that the variation may include:

1). If data is coded with a coder of length 6. N=64, Tail=6 TailConst=63.

2). If data is coded with a coder of length 8. N=256, Tail=8 TailConst=255.

3). In all cases Symbols is the length of the original data encoded in bits.

The Viterbi Butterfly algorithm works on 2 sequential states at a time adding a pre-determined “distance” to 1 value whilst subtracting it from the other value. It then selects the maximum of the two results and outputs a decision bit as to which was the maximum. It makes a second output for a second maximum and a second decision by reversing the addition and subtraction, as shown in FIG. 5. The complete form is shown on the left, whilst a simplified representation commonly known as the “Radix-2 Viterbi Butterfly” is shown on the right.

Traditionally in a DSP (digital signal processor) this building block is implemented with traditional separate add, sub, max and cmp instructions. In later DSP's with the advent of SIMD (Single Instruction Multiple Data), parallelism is possible by either paralleling the adds, subs, maxs and cmps into add2's sub2's max2's and cmp2's or by creating additional instructions like addsub to pair an add or subtract or even ACS (add, compare select) instructions, but the finite data-word length and the need for around 16 bits of precision has limited the ability of instructions to perform bigger blocks.

With the advent of wider data paths and registers in the newest processors, more channels can be paralleled. At 16 bits per state variable and 128-bits per register it is now possible to input more states at a time. The extension is therefore to parallel up 4 “butterflys”.

Alternative solutions available today use custom logic in the form of FPGA's, ASIC's or even full custom designs, these typically perform an alternative form of parallelism, by pairing 2 butterflys from 1 stage with two butterflys from the next outer loop, as shown in FIG. 6.

As the decision of the second stage is for all four outputs, it is possible to determine which of the 4 decisions made at the first stage would have lead to the second decision and these decision results can be merged into 4 two bit decisions instead of 8 one-bit decisions. This allows the second feed-back (loop 2) in the first diagram to work on 2 bits at a time halving this loops work. This is also known as a Radix-4 Viterbi Butterfly, and can be simplified to the below left diagram, where the add's and sub's are rearranged to do a 4-way maximum and decision. FIG. 7 is a simplified depiction often used for this stage.

It is possible to further expand this technique to perform radix-8 or radix-16 stages, but as the most common uses of this architecture are to decode length 6 and 8 convolution encoded data the use of radix's higher than radix-4 do not produce good building blocks. Similar to the DSP, radix-4 stages can be paralleled to perform multiple radix-4 stages in parallel, due to the parallel nature of FPGA's and ASIC's, this is a straightforward speed v's area compromise. Where very high speed is needed higher radix-s are used.

Using the radix-4 technique for DSP has in the past proved difficult due to the non-ordered nature of the output (alternatively the input can be out of order and the output in order). This is solved in an FPGA/ASIC environment by selectively crossing the address lines between write's and reads from memory but this is not allowed in the DSP/CPU world where fixed address lines are de-facto mandatory. The relatively short data word widths of past DSP's have also made this unpromising.

However, with high data width accelerator 16-bit states may be read in parallel. Thus, one can utilize the 8 radix-2 stages in parallel, which has relatively easy ordering or 2 radix-4 stages in parallel and has more ordering problems, although it has execution speed advantages.

In one embodiment, the method of decoding consists of taking the radix-4 approach from the FPGA, ASIC and custom world and modifying it to work in the DSP world in such a ways to get around the output ordering problems.

The array of states used in the Viterbi algorithm is nominally ordered so that 0 is the state corresponding to a binary representation of 0 in the coding algorithm, 1 for 1 all the way up to 63 for 63 if the coder length is 6 (or 255 for 255 if the coder length is 8). This logical ordering serves well for both traditional FPGA/ASIC or DSP systems; however, as the array is internal to the first loop, there is actually no need for this conformity.

FIG. 8 shows 3 orders for ordering states in the two radix-4 stage solution. The left most one is the input [0,1,2,3,4,5,6,7] output [0,N/4,N/2,3N/4,1,N/4+1,N/2+1 ,3N/4+1] order, in the middle case the input order is changed to [0,1,4,5,2,3,6,7] and finally in the right most one the output order is changed to [0,1,N/4,N/4+1,N2,N2+1,3N/4,3N/4+1]. With a 128-bit data path and 16-bit data these represent the maximum of data that can be transferred to an instruction, from a register-pair.

These data orders are implemented as the instructions R4ACS (Radix-4 Add [Subtract] Compare Select) producing the state outputs and R4ACD (Radix-4 Add [Subtract] Compare Decision) producing the decision outputs. FIG. 9 shows the implementation of 4 inner loops and 2 outer loops of the first stage. This ordering vastly reduces the amount of reordering needed to be done by the DSP at the next stage. As each register of the output register pairs, contains [0,1,N/4,N/4+1] & [N2,N2+1 ,3N/4,3N/4+1] by swapping the high register from the output of one stage with the low register from the next inner loop, Then the outputs of these 2 instructions can be used to feed another two instructions, overall producing 8 inner loops and 4 outer loops with only inter-register reordering and no intra-register reloading as shown in FIG. 9. This combination of instructions implements a radix-16 stage.

For the second stage one more instruction is added: REG _pretrc4 ( REGPAIR op1, REGPAIR op2). This allows a 4-stage trellis for 16 states to be packed into a 64-bit register. By interleaving Nibbles this can be arbitrarily extended to a higher state trellis. After performing the 4 R4ACS stages, wherein the 4 16 bit values describe the trace-back of 8 2-bit stages. By reading these 4 registers as two register pairs this can be converted from 4 sets of eight 2-bit stages to 1 set of 16 4-bit stages, as shown in FIG. 10.

While the foregoing is directed to embodiments of the present invention, other and further embodiments of the invention may be devised without departing from the basic scope thereof, and the scope thereof is determined by the claims that follow.

What is claimed:

1. A high data width accelerator, comprising computer instructions for calculating at least a portion of a trace-back during a trellis computation, wherein the calculation allows faster trace-back

2. The high data width accelerator of claim 1 further comprising an input comprising at least one of at least 4 sets of an 8 2-bit decision or an output set of 16 4-bit decision.

3. The high data width accelerator of claim 1, wherein a 4-stage trellis for 16 states is packed into a 64-bit register.

4. The high data width accelerator of claim 1, wherein the instructions are at least one of Radix-4 Add Subtract Compare Decision or Radix-4 Add Subtract Compare Select.

5. The high data width accelerator of claim 1, wherein the Radix-4 Add Subtract Compare Select produces a state output.

6. The high data width accelerator of claim 1, wherein Radix-4 Add Subtract Compare Decision produces a decision output.
